(19) United States
(12) Patent Application Publication
(10) Pub. No.: US 2025/0073911 A1
(43) Pub. Date: Mar. 6, 2025

(54) EMBRACING CRAWLING ROBOT FOR DETECTING UNDERWATER PIER OF HIGHWAY BRIDGE AND DETECTION METHOD THEREFOR

(71) Applicant: SOUTHEAST UNIVERSITY, Jiangsu (CN)

(72) Inventors: Guangming SONG, Jiangsu (CN); Feng XIE, Jiangsu (CN); Juzheng MAO, Jiangsu (CN); Fei WANG, Jiangsu (CN); Jun ZHOU, Jiangsu (CN); Aiguo SONG, Jiangsu (CN); Gang WU, Jiangsu (CN)

(73) Assignee: SOUTHEAST UNIVERSITY, Jiangsu (CN)

(21) Appl. No.: 18/896,856

(22) Filed: Sep. 25, 2024

Related U.S. Application Data
(63) Continuation of application No. PCT/CN2023/131006, filed on Nov. 10, 2023.

(30) Foreign Application Priority Data
Sep. 5, 2023 (CN) 202311143125.5

(51) Int. Cl. B25J 11/00; B25J 5/00; B25J 9/16

(52) U.S. Cl. CPC B25J 11/005; B25J 5/007; B25J 9/1697

(57) ABSTRACT

Disclosed are an embracing crawling robot for detecting an underwater pier of a highway bridge and a detection method therefor. The robot includes a main body, underwater lighting systems, tool compartments, depth metering modules, servo driving wheels, inclination measurement modules, underwater manipulator arms, vision array modules, synchronized stretching and fixing systems, and driven wheels. The robot is capable of crawling around an underwater pier of a highway bridge and operating stably in an underwater environment. After cleaning surface attachments on the underwater pier, the robot performs visual detection of a disease; and after determining type and location information of the disease, the robot will transmit disease information back. The robot is capable of crawling around the underwater pier of the highway bridge stably at any depths, perceiving depth and visual information under high-speed and turbid water conditions, thereby realizing detection of the disease on the underwater pier.

### CROSS-REFERENCE TO RELATED APPLICATIONS

This application is a continuation of international PCT application serial no. PCT/CN2023/131006, filed on Nov. 10, 2023, which claims the priority benefit of China application no. 202311143125.5, filed on Sep. 5, 2023. The entirety of each of the above mentioned patent applications is hereby incorporated by reference herein and made a part of this specification.

### TECHNICAL FIELD

The present disclosure relates to the technical field of underwater detection and maintenance robots, and particularly relates to an embracing crawling robot for detecting an underwater pier of a highway bridge and the detection method therefor.

### DESCRIPTION OF RELATED ART

China has a vast number of highway bridges, of which a proportion in service for more than 20 years is continuously increasing, resulting in a growing demand for large-scale maintenance of highway bridges. However, the service safety of underwater piers, as an important constituent of a bridge structure, is very important, but no technical means are available to maintain the underwater piers of highway bridges at present, severe shortage of theoretical research, technical standards and equipment seriously restricts the development of scientific maintenance of highway bridges across China. Therefore, conducting research on key technologies for detecting the underwater piers of highway bridges is of great economic and social significance of promoting the sustainable transformation and upgrading of transportation infrastructure in China and accelerating the construction of a country with great transport strength.

Traditional detection and assessment of underwater piers of highway bridges are mainly conducted manually, which faces the problems of high risks, low efficiency, and poor accuracy: (1) manual cleaning of underwater piers is very difficult, costly and inefficient, and is difficult to meet cleaning needs of large quantities and in wide areas; and (2) manual detection of underwater piers is risky, time-consuming, and difficult to implement in complex environments such as high speed, and turbid water flow. Therefore, developing automated equipment for cleaning, detection, and assessment is a necessary way to overcome the difficulties of manual underwater detection.

An underwater robot can run for a long period of time and over a long distance, nevertheless, existing underwater robots for bridges are mainly remotely operated vehicle, at present, and are incapable of performing pier cleaning tasks, and moreover, underwater water flow can reach a speed of more than 2 knots. Under such high-speed, turbid flow conditions, the existing underwater robots cannot meet the maintenance needs of highway bridges. In contrast, an underwater pier-embracing robot for bridges is more stable and reliable.

In summary, no mature precedents for integrated cleaning and detection equipment for underwater piers of highway bridges are available both at home and abroad, and intelligent detection systems are still blank. Therefore, an intelligent underwater robot capable of performing cleaning and detection tasks simultaneously is needed.

### SUMMARY

In view of the disease on the prior art, the present disclosure provides an embracing crawling robot for detecting an underwater pier of a highway bridge and the detection method therefor.

The present disclosure implements the following technical solution:

An embracing crawling robot for detecting an underwater pier of a highway bridge, where the robot includes a main body, underwater lighting systems, tool compartments, depth metering modules, servo driving wheels, inclination measurement modules, underwater manipulator arms, vision array modules, synchronized stretching and fixing systems, and driven wheels; the main body adopts a dual-combination octagonal hollow frame structure, which is fixed on the underwater pier of the highway bridge and is configured to reduce resistance caused by high-speed water flow, and the main body is composed of carbon fiber pipes, exhibiting high strength and light weight; the systems and the modules perform power and communication transmission through a main body structure; four sets of the servo driving wheels are provided and evenly distributed on an upper end of the main body in a circumferential direction for providing power to the underwater pier of the highway bridge, each of the servo driving wheels includes a wiring cover, a servo motor, a waterproof motor sleeve, a locating shoulder, a static coupling shaft, tires, and dynamic coupling shafts; four sets of the driven wheels are provided and evenly distributed on a lower end of the main body in the circumferential direction, and each set of the driven wheels vertically corresponds to one set of the servo driving wheels and is rotatably connected to the main body through a swing frame; each of the synchronized stretching and fixing systems is composed of a waterproof pen-type electric pull rod and an underwater tension sensor, which connects inner sides of the swing frames corresponding to the servo driving wheels and the driven wheels and provides synchronous tension, and the provided synchronous tension squeezes the tires of each set of the servo driving wheels and the driven wheels tightly onto a surface of the underwater pier of the highway bridge, such that the robot is capable of stably embracing the highway bridge to fix the same.

As a further improved solution of the present disclosure, two sets of the vision array modules are provided and located on a lower side of the main body and are composed of an underwater camera array to provide full-view visual information to facilitate the detection of a disease on the underwater pier of the highway bridge and the transmission of visual data; four sets of the underwater lighting systems are provided and located on both sides of the vision array modules to provide visual lighting conditions in a turbid water environment; each of the depth metering modules is mounted at a center of an outer wall of each of the tool compartments to collect water depth information; and each of the inclination measurement modules are mounted on an upper wall of each of the tool compartments near the underwater manipulator arms to provide posture information of the robot, which is used for anti-deflection control.

As a further improved solution of the present disclosure, two sets of the underwater manipulator arms are symmetrically distributed on an upper side of the main body; each of the tool compartments is mounted on an inner side of each of the underwater manipulator arms on a same side, each of the tool compartments includes cylindrical chambers, a cover plate, and a cover plate slot, and contains operating tools for cleaning inside, a gripper is mounted at an end of each of the underwater manipulator arms, and each of the underwater manipulator arms is thus capable of gripping the operating tools from the corresponding tool compartment.

A detection method for the embracing crawling robot for detecting an underwater pier of a highway bridge, including the following steps:
S1. an operator assembles a two-sided structure of the robot into an octagonal shape on a water surface platform, and remotely controls the waterproof pen-type electric pull rod using a cable to press four tires and four driven wheels of the robot tightly against the underwater pier of the highway bridge until the robot slides down without being affected by gravity;
S2. the operator remotely turns on the servo driving wheels, the depth metering modules, the inclination measurement modules, the vision array modules, and the underwater lighting systems using the cable, sets parameters to prepare for starting a cleaning task; during crawling of the robot, the inclination measurement modules continuously collect posture information of the robot; and the robot makes use of the posture information to control a pitch angle and a roll angle, so as to keep the robot in a stable and balanced state;
S3. after the robot reaches an appropriate depth, the underwater manipulator arms on both sides are used to perform the cleaning task; the cover plates of the tool compartments are opened, the underwater manipulator arms on both sides grip high-pressure water guns from the tool compartments, and the cover plates are closed after the underwater manipulator arms take out the high-pressure water guns; the servo driving wheels are enabled after the cover plates are closed, the robot then crawls downward along the underwater pier, and two sets of the high-pressure water guns thoroughly wash the underwater pier of the highway bridge during the crawling of the robot; and when the robot reaches a water bottom, the cleaning task is completed, and the underwater manipulator arms put the high-pressure water guns back to the tool compartments;
S4. after the high-pressure water guns are put back, the robot grips steel brushes for a scrubbing task from the tool compartments to perform the scrubbing task; the servo driving wheels are enabled after the cover plates are closed, the robot then crawls upward along the underwater pier, and two sets of the steel brushes thoroughly scrub and clean the underwater pier of the highway bridge; and after the robot returns to the water surface, the scrubbing task is completed, and the underwater manipulator arms put the steel brushes back to the tool compartments; and
S5: after the scrubbing task is completed, the robot returns to the water surface and starts a detection task; the vision array module approaches the underwater pier of the highway bridge to perform visual detection, and transmits visual information back to a ground station; at the same time, the underwater lighting systems adjust their angles to provide suitable lighting conditions; the robot crawls slowly from top to bottom, and when the disease on the underwater pier of the highway bridge is detected, the vision array modules automatically identify a disease type, the depth metering modules record underwater depth information of the disease and transmits disease information and the depth information back to the ground station; and after completing the detection task, the robot returns to the water surface.

The present disclosure has the beneficial effects:

The embracing crawling robot for detecting an underwater pier of a highway bridge and a detection method therefor provided in the present disclosure are capable of performing underwater cleaning operations and automatically detecting typical diseases of the underwater pier of highway bridge. It can maintain the underwater pier of highway bridge under high-speed and turbid water conditions, effectively improving the efficiency of treating underwater diseases of bridges.

### BRIEF DESCRIPTION OF THE DRAWINGS

FIG. 1 is a schematic diagram of an underwater robot mounted on an underwater pier according to the present disclosure.

FIG. 2 is a schematic diagram of an underwater robot performing operation on an underwater pier of a highway bridge according to the present disclosure.

FIG. 3 is a side view of an underwater robot according to the present disclosure.

FIG. 4 is a top view of an underwater robot according to the present disclosure.

FIG. 5 is a sectional view of a servo driving wheel of an underwater robot according to the present disclosure.

FIG. 6 is a schematic diagram of a synchronized stretching and fixing system of an underwater robot according to the present disclosure.

FIG. 7 is a sectional view of a tool compartment of an underwater robot according to the present disclosure.

Reference numerals in the figures: 1. main body; 2. underwater lighting system; 3. tool compartment; 31. cylindrical chamber; 32. cover plate; 33. cover plate slot; 4. depth metering module; 5. servo driving wheel; 51. wiring cover; 52. servo motor; 53. waterproof motor sleeve; 54. locating shoulder; 55. static coupling shaft; 56. tire; 57. dynamic coupling shaft; 6. inclination measurement module; 7. underwater manipulator arm; 8. vision array module; 9. synchronized stretching and fixing system; 91. waterproof pen-type electric pull rod; 92. underwater tension sensor; 10. driven wheels; and 11. underwater pier.

### DESCRIPTION OF THE EMBODIMENTS

The present disclosure will be further described below with reference to the accompanying drawings.

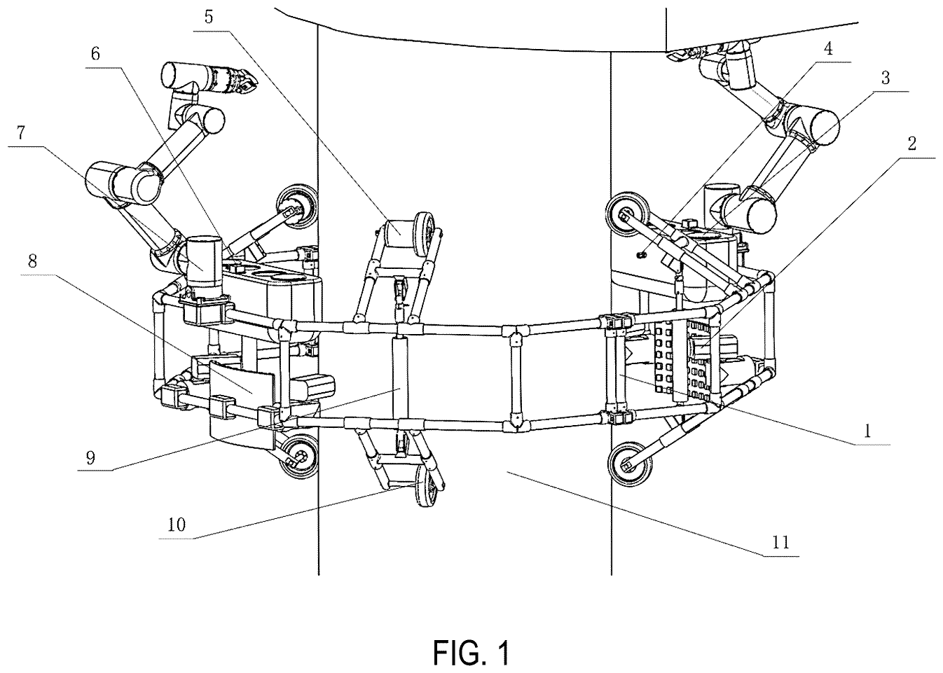

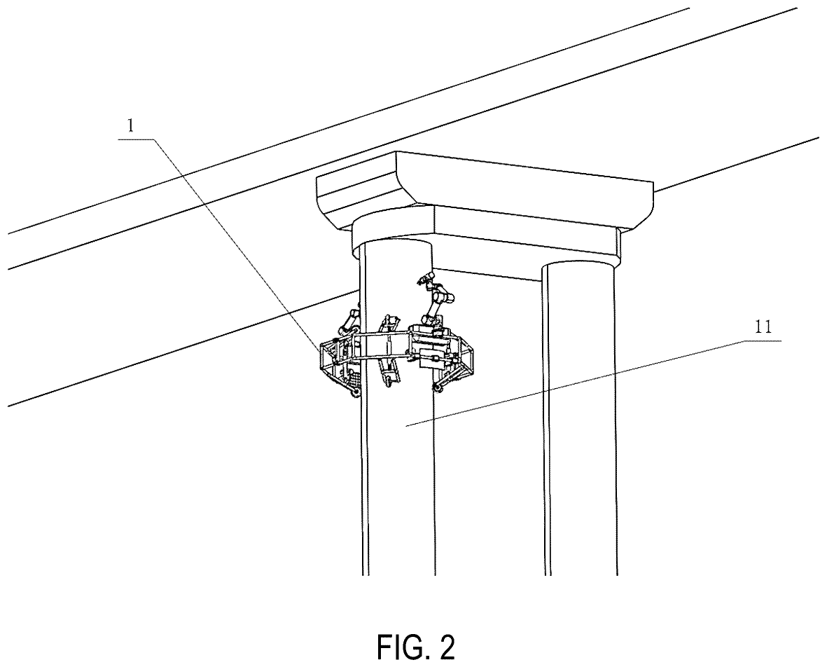

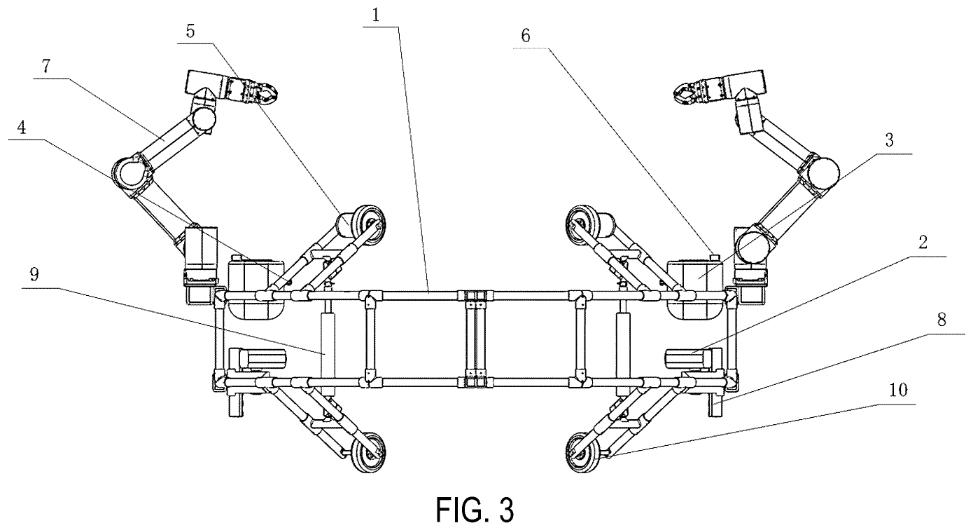

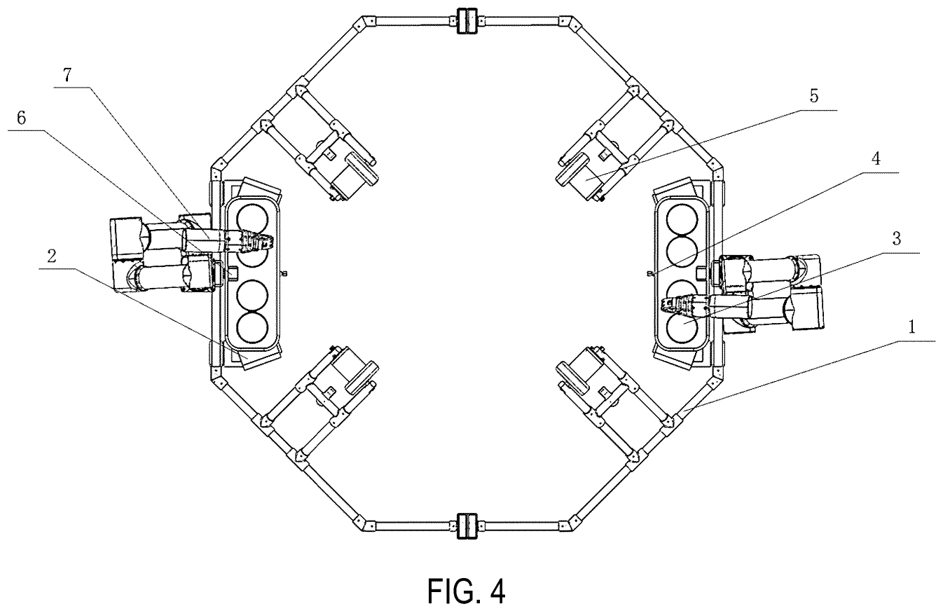

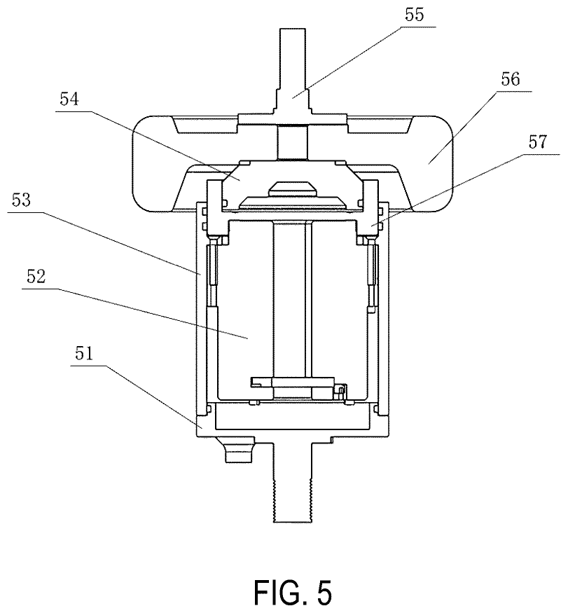

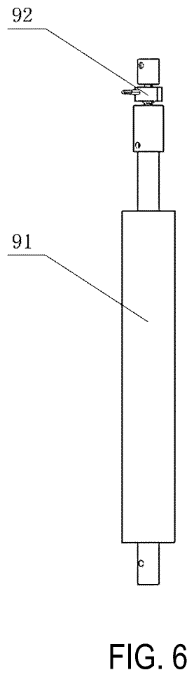

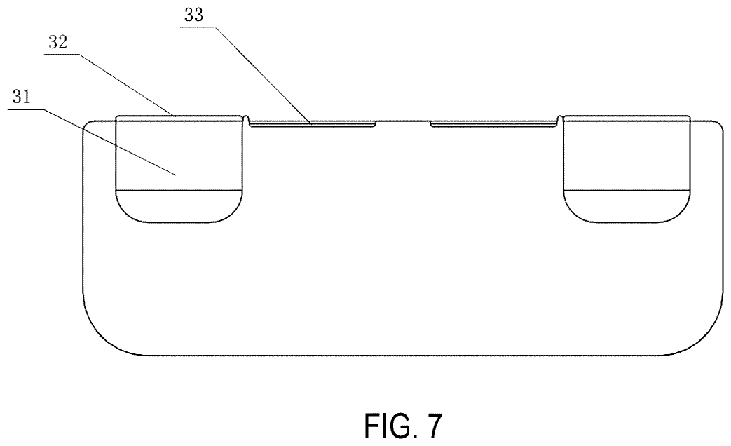

As shown in FIGS. 1-7, the present disclosure provides an embracing crawling robot for detecting an underwater pier of a highway bridge, including a main body 1, underwater lighting systems 2, tool compartments 3, depth metering modules 4, servo driving wheels 5, inclination measurement modules 6, underwater manipulator arms 7, vision array modules 8, synchronized stretching and fixing systems 9, and driven wheels 10; the main body 1 adopts a dual-combination octagonal hollow frame structure, which is fixed on an underwater pier 11 of a highway bridge and reduces resistance caused by high-speed water flow, and the main body 1 is composed of carbon fiber pipes, exhibiting high strength and light weight; the systems and the modules perform power and communication transmission through a main body structure; four sets of the servo driving wheels 5 are provided and evenly distributed on an upper end of the main body 1 in a circumferential direction for providing power to the underwater pier 11 of the highway bridge, each of the servo driving wheels 5 includes a wiring cover 51, a servo motor 52, a waterproof motor sleeve 53, a locating shoulder 54, a static coupling shaft 55, tires 56, and dynamic coupling shafts 57; four sets of the driven wheels 10 are provided and evenly distributed on a lower end of the main body 1 in the circumferential direction, and each set of the driven wheels 10 vertically corresponds to one set of the servo driving wheels 5 and is rotatably connected to the main body 1 through a swing frame; each of the synchronized stretching and fixing systems 9 is composed of a waterproof pen-type electric pull rod 91 and an underwater tension sensor 92, which connects inner sides of the swing frames corresponding to the servo driving wheels 5 and the driven wheels 10 and provides synchronous tension, and the provided synchronous tension squeezes the tires 56 of each set of the servo driving wheels 5 and the driven wheels 10 tightly onto a surface of the underwater pier of the highway bridge, such that the robot is capable of stably embracing the highway bridge to fix the same.

In this example, two sets of the vision array modules 8 are provided and located on a lower side of the main body 1 and are composed of an underwater camera array to provide full-view visual information to facilitate the detection of a disease on the underwater pier of the highway bridge and the transmission of visual data; four sets of the underwater lighting systems 2 are provided and located on both sides of the vision array modules 8 to provide visual lighting conditions in a turbid water environment; each of the depth metering modules 4 is mounted at a center of an outer wall of each of the tool compartments 3 to collect water depth information; and each of the inclination measurement modules 6 are mounted on an upper wall of each of the tool compartments 3 near the underwater manipulator arms 7 to provide posture information of the robot, which is used for anti-deflection control.

In this example, two sets of the underwater manipulator arms 7 are symmetrically distributed on an upper side of the main body 1; each of the tool compartments 3 is mounted on an inner side of each of the underwater manipulator arms 7 on a same side, each of the tool compartments 3 includes cylindrical chambers 31, a cover plate 32, and a cover plate slot 33, and contains operating tools for cleaning inside, a gripper is mounted at an end of each of the underwater manipulator arms 7, and each of the underwater manipulator arms 7 is thus capable of gripping the operating tools from the corresponding tool compartment 3.

A detection method for the embracing crawling robot for detecting an underwater pier of a highway bridge, including the following steps:
S1. an operator assembles a two-sided structure of the robot into an octagonal shape on a water surface platform, and remotely controls the waterproof pen-type electric pull rod 91 using a cable to press four tires 56 and four driven wheels 10 of the robot tightly against the underwater pier of the highway bridge until the robot slides down without being affected by gravity;
S2. the operator remotely turns on the servo driving wheels 5, the depth metering modules 4, the inclination measurement modules 6, the vision array modules 8, and the underwater lighting systems 2 using the cable, sets parameters to prepare for starting a cleaning task; during crawling of the robot, the inclination measurement modules 6 continuously collect posture information of the robot; and the robot makes use of the posture information to control a pitch angle and a roll angle, so as to keep the robot in a stable and balanced state;
S3. after the robot reaches an appropriate depth, the underwater manipulator arms 7 on both sides are used to perform the cleaning task; the cover plates 32 of the tool compartments 3 are opened, the underwater manipulator arms 7 on both sides grip high-pressure water guns from the tool compartments 3, and the cover plates 32 are closed after the underwater manipulator arms 7 take out the high-pressure water guns; the servo driving wheels 5 are enabled after the cover plates 32 are closed, the robot then crawls downward along the underwater pier, and two sets of the high-pressure water guns thoroughly wash the underwater pier of the highway bridge during the crawling of the robot; and when the robot reaches a water bottom, the cleaning task is completed, and the underwater manipulator arms 7 put the high-pressure water guns back to the tool compartments 3;

S4. after the high-pressure water guns are put back, the robot grips steel brushes for a scrubbing task from the tool compartments 3 to perform the scrubbing task; the servo driving wheels 5 are enabled after the cover plates 32 are closed, the robot then crawls upward along the underwater pier, and two sets of the steel brushes thoroughly scrub and clean the underwater pier of the highway bridge; and after the robot returns to the water surface, the scrubbing task is completed, and the underwater manipulator arms 7 put the steel brushes back to the tool compartments 3; and
S5: after the scrubbing task is completed, the robot returns to the water surface and starts a detection task; the vision array modules 8 approach the underwater pier of the highway bridge to perform visual detection, and transmits visual information back to a ground station; at the same time, the underwater lighting systems 2 adjust their angles to provide suitable lighting conditions; the robot crawls slowly from top to bottom, and when the disease on the underwater pier of the highway bridge is detected, the vision array modules 8 automatically identify a disease type, the depth metering modules 4 record underwater depth information of the disease and transmits disease information and the depth information back to the ground station; and after completing the detection task, the robot returns to the water surface.

The technical means disclosed in the present disclosure are not limited to the foregoing embodiments, but also include the technical solutions composed of any combination of the above technical features. It should be pointed out that those of ordinary skill in the art may also make some improvements and modifications without departing from the principle of the present disclosure, and these improvements and modifications should also fall within the scope of protection of the present disclosure.

What is claimed is:

1. An embracing crawling robot for detecting an underwater pier of a highway bridge, comprising a main body, underwater lighting systems, tool compartments, depth metering modules, servo driving wheels, inclination measurement modules, underwater manipulator arms, vision array modules, synchronized stretching and fixing systems, and driven wheels; wherein the main body adopts a dual-combination octagonal hollow frame structure, which is fixed on the underwater pier of the highway bridge and is configured to reduce resistance caused by high-speed water flow, and the main body is composed of carbon fiber pipes, exhibiting high strength and light weight; the systems and the modules perform power and communication transmission through a main body structure; four sets of the servo driving wheels are provided and evenly distributed on an upper end of the main body in a circumferential direction for providing power to the underwater pier of the highway bridge, each of the servo driving wheels comprises a wiring cover, a servo motor, a waterproof motor sleeve, a locating shoulder, a static coupling shaft, tires, and dynamic coupling shafts; four sets of the driven wheels are provided and evenly distributed on a lower end of the main body in the circumferential direction, and each set of the driven wheels vertically corresponds to one set of the servo driving wheels and is rotatably connected to the main body through a swing frame; each of the synchronized stretching and fixing systems is composed of a waterproof pen-type electric pull rod and an underwater tension sensor, which connects inner sides of the swing frames corresponding to the servo driving wheels and the driven wheels and provides synchronous tension, and the provided synchronous tension squeezes the tires of each set of the servo driving wheels and the driven wheels tightly onto a surface of the underwater pier of the highway bridge, such that the robot is capable of stably embracing the highway bridge to fix the same.

2. The embracing crawling robot for detecting an underwater pier of a highway bridge according to claim 1, wherein two sets of the vision array modules are provided and located on a lower side of the main body and are composed of an underwater camera array to provide full-view visual information to facilitate the detection of a disease on the underwater pier of the highway bridge and the transmission of visual data; four sets of the underwater lighting systems are provided and located on both sides of the vision array modules to provide visual lighting conditions in a turbid water environment; each of the depth metering modules is mounted at a center of an outer wall of each of the tool compartments to collect water depth information; and each of the inclination measurement modules are mounted on an upper wall of each of the tool compartments near the underwater manipulator arms to provide posture information of the robot, which is used for anti-deflection control.

3. The embracing crawling robot for detecting an underwater pier of a highway bridge according to claim 1, wherein two sets of the underwater manipulator arms are symmetrically distributed on an upper side of the main body; each of the tool compartments is mounted on an inner side of each of the underwater manipulator arms on a same side, each of the tool compartments comprises cylindrical chambers, a cover plate, and a cover plate slot, and contains operating tools for cleaning inside, a gripper is mounted at an end of each of the underwater manipulator arms, and each of the underwater manipulator arms is thus capable of gripping the operating tools from the corresponding tool compartment.

4. A detection method for the embracing crawling robot for detecting an underwater pier of a highway bridge according to claim 1, comprising the following steps:
S1. an operator assembles a two-sided structure of the robot into an octagonal shape on a water surface platform, and remotely controls the waterproof pen-type electric pull rod using a cable to press four tires and four driven wheels of the robot tightly against the underwater pier of the highway bridge until the robot slides down without being affected by gravity;
S2. the operator remotely turns on the servo driving wheels, the depth metering modules, the inclination measurement modules, the vision array modules, and the underwater lighting systems using the cable, sets parameters to prepare for starting a cleaning task; during crawling of the robot, the inclination measurement modules continuously collect posture information of the robot; and the robot makes use of the posture information to control a pitch angle and a roll angle, so as to keep the robot in a stable and balanced state;
S3. after the robot reaches an appropriate depth, the underwater manipulator arms on both sides are used to perform the cleaning task; the cover plates of the tool compartments are opened, the underwater manipulator arms on both sides grip high-pressure water guns from the tool compartments, and the cover plates are closed after the underwater manipulator arms take out the high-pressure water guns; the servo driving wheels are enabled after the cover plates are closed, the robot then crawls downward along the underwater pier, and two sets of the high-pressure water guns thoroughly wash the underwater pier of the highway bridge during the crawling of the robot; and when the robot reaches a water bottom, the cleaning task is completed, and the underwater manipulator arms put the high-pressure water guns back to the tool compartments;
S4. after the high-pressure water guns are put back, the robot grips steel brushes for a scrubbing task from the tool compartments to perform the scrubbing task; the servo driving wheels are enabled after the cover plates are closed, the robot then crawls upward along the underwater pier, and two sets of the steel brushes thoroughly scrub and clean the underwater pier of the highway bridge; and when the robot returns to a water surface, the scrubbing task is completed, and the underwater manipulator arms put the steel brushes back to the tool compartments; and
S5: after the scrubbing task is completed, the robot returns to the water surface and starts a detection task; the vision array modules approach the underwater pier of the highway bridge to perform visual detection, and transmits visual information back to a ground station; at the same time, the underwater lighting systems adjust their angles to provide suitable lighting conditions; the robot crawls slowly from top to bottom, and when the disease on the underwater pier of the highway bridge is detected, the vision array modules automatically identify a disease type, the depth metering modules record underwater depth information of the disease and transmits disease information and the depth information back to the ground station; and after completing the detection task, the robot returns to the water surface.
